(19) United States
(12) Patent Application Publication
(10) Pub. No.: US 2017/0011575 A1
(43) Pub. Date: Jan. 12, 2017

(54) INFORMATION KIOSK STYLE VOTING MACHINE

(71) Applicant: Nicholas G. Sotereanos, McKeesport, PA (US)

(72) Inventor: Nicholas G. Sotereanos, McKeesport, PA (US)

(21) Appl. No.: 15/196,868

(22) Filed: Jun. 29, 2016

Related U.S. Application Data
(60) Provisional application No. 62/189,538, filed on Jul. 7, 2015.

(51) Int. Cl. G07C 13/00

(52) U.S. Cl. CPC G07C 13/00

(57) ABSTRACT

An electronic voting system is disclosed. The electronic voting system comprises a kiosk comprising a monetization module, an electronic user interface, a recording and transmitting module, and a voting device. The voting device comprises an electronic display screen, wherein the electronic display screen is configured to receive inputs from the kiosk to display an image. The voting device further comprises a voting registration means, wherein the means is configured to register a vote from user initiated actions. The voting device comprises a communication unit, wherein the communication unit is configured to register the vote and communicate with the kiosk, wherein the kiosk is configured to transmit the vote to a server, wherein the server is configured to communicate record the results from multiple kiosks, and wherein the server is configured to communicate the results to the kiosk, and wherein the kiosk is configured to display the results.

### CROSS-REFERENCE TO RELATED APPLICATIONS

This application claims the benefit under Title 35, United States Code §119(e), of U.S. Provisional Patent Application Ser. No. 62/189,538 entitled INFORMATION KIOSK STYLE VOTING MACHINE, filed on Jul. 7, 2015, the entire disclosure of which is herein incorporated by reference.

### FIELD OF TECHNOLOGY

The present disclosure is related to an electronic voting machine activated by the act of micturition (urination), flushing, washing, rinsing, defecation, or other activation means. More particularly, the present disclosure is related to an electronic voting system that monetizes a user input, permits the user to cast votes, communicates with a network, tabulates the results and provides visual depiction of the votes on a website, local voting kiosk or display, and mobile devices.

### BACKGROUND

Public restrooms are a necessarily for any type of business. Where businesses provide beverages or meals to their customers, restroom facilities have an even greater role. However, utilizing the restroom may take the customer away from the atmosphere of the business and detract from the customer's engagement. This inevitably reduces the revenue of the business.

Current restroom facilities include paper advertisements and small vendor services such as breath mints and cologne or perfume. However, these facilities lack an atmosphere to engage the customer and often time result in underutilized interaction, as many customers are bored or are on their mobile devices, which detracts from the business environment. Thus, the traditional restroom facility is lacking in the ability to stimulate, engage, and interact with the customer, which potentially results in lost revenue to the business. Therefore, there is a need for an improved restroom facility and entertainment devices which engages and interacts with the customer to maintain the customer's attention and to generate addition revenue and marketing avenues for the business.

### SUMMARY

In one embodiment, the present disclosure provides an electronic voting system to permit interaction and engagement of a user while utilizing a restroom facility. The electronic voting system comprises a kiosk comprising a monetization module, an electronic user interface, and a recording and transmitting module. The electronic voting system further comprises a voting device. The voting device comprises an electronic display screen, wherein the electronic display screen is substantially fluid resistant, wherein the electronic display screen is configured to receive inputs from the kiosk to display an image. The voting device further comprises a voting registration means, wherein the means is configured to register a vote from the actions of the group consisting of urination, defecation, hand washing, toilet flushing, and bidet activation. The voting device comprises a communication unit, wherein the communication unit is configured to register the vote and communicate with the kiosk, wherein the kiosk is configured to transmit the vote to a server, wherein the server is configured to communicate and record the results from multiple kiosks, and wherein the server is configured to communicate the results to the kiosk, and wherein the kiosk is configured to display the results.

### FIGURES

The novel features of the embodiments described herein are set forth with particularity in the appended claims. The embodiments, however, both as to organization and methods of operation may be better understood by reference to the following description, taken in conjunction with the accompanying drawings as follows.

FIG. 1 is an illustration of an electronic voting system.

FIG. 2 is an illustration of a voting kiosk of the electronic voting system shown in FIG. 1.

FIG. 3 is an illustration of an electronic voting device of the electronic voting system shown in FIG. 1.

### DESCRIPTION

In the following detailed description, reference is made to the accompanying drawings, which form a part hereof. In the drawings, similar symbols and reference characters typically identify similar components throughout the several views, unless context dictates otherwise. The illustrative embodiments described in the detailed description, drawings, and claims are not meant to be limiting. Other embodiments may be utilized, and other changes may be made, without departing from the spirit or scope of the subject matter presented here.

Before explaining the various embodiments of the electronic voting system in detail, it should be noted that the various embodiments disclosed herein are not limited in their application or use to the details of construction and arrangement of parts illustrated in the accompanying drawings and description. Rather, the disclosed embodiments may be positioned or incorporated in other embodiments, variations and modifications thereof, and may be practiced or carried out in various ways. Accordingly, embodiments of the voting system and voting device disclosed herein are illustrative in nature and are not meant to limit the scope or application thereof. Furthermore, unless otherwise indicated, the terms and expressions employed herein have been chosen for the purpose of describing the embodiments for the convenience of the reader and are not to limit the scope thereof. In addition, it should be understood that any one or more of the disclosed embodiments, expressions of embodiments, and/or examples thereof, can be combined with any one or more of the other disclosed embodiments, expressions of embodiments, and/or examples thereof, without limitation.

Also, in the following description, it is to be understood that terms such as front, back, inside, outside, top, bottom and the like are words of convenience and are not to be construed as limiting terms. Terminology used herein is not meant to be limiting insofar as devices described herein, or portions thereof, may be attached or utilized in other orientations. The various embodiments will be described in more detail with reference to the drawings.

In today's world of global politics, the average citizen of a free society can be rendered disenfranchised by the perceived inconsequence of one vote diluted amongst millions. The electronic voting system will enable the disenfranchised to have their views potentially seen and heard with the added weight of monetary expense associated to the individualized votes of extreme disdain.

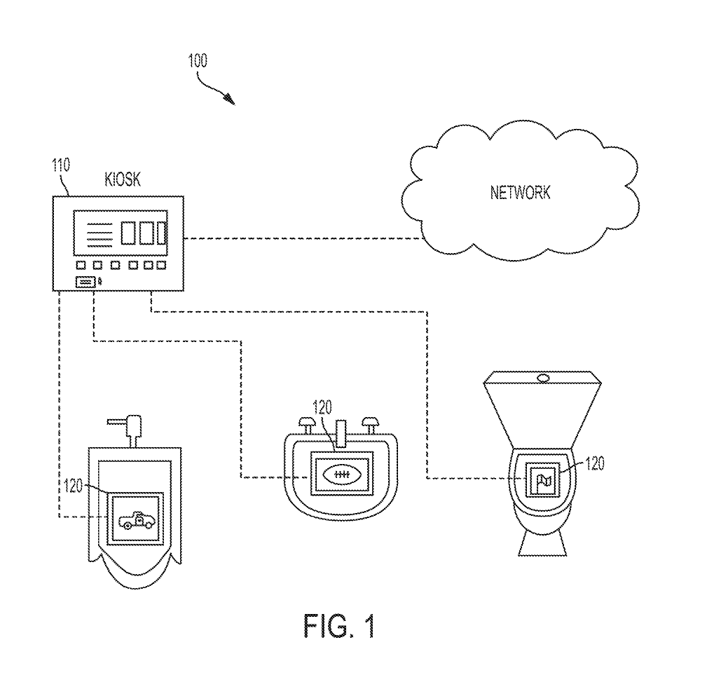

FIG. 1 is an illustration of an electronic voting system 100 configured register votes through acts micturition (urination), flushing, washing, rinsing, defecation, or other sensor and activation means. Votes may by paid for prior to casting by insertion of some predetermined denomination. Alternatively, other monetization techniques, such as user registration for use in future marketing and advertisement communications may be employed. In addition, the votes may be free or tied to promotional giveaways. The votes are intended to be votes of distain, generally profoundly negative to the object or person on which the vote has been cast. Voters may remain anonymous or may receive rewards, prizes, or recognition for their votes.

The votes are tabulated and communicated between the voting system 100, the voting kiosk 110 and the voting device 120. The votes are communicated to the network and are displayed on a website. In addition, each user may download an application to a mobile device to view real time voting and results across the country and world. The results are sortable by category and at various times, competitions may be ongoing between certain groups or entities attempting to obtain votes. The votes may also be linked to social media campaigns and fundraising for non-profit organizations, such as the Red Cross or American Heart Association, where proceeds or donations for voting can be donated to the organization.

The electronic voting system 100, as shown in FIG. 1, comprises a voting kiosk 110. The voting kiosk 110 allows a user to preregister their vote prior to using the restroom facilities. The user may select from numerous categories to vote on, including, but not limited to actors, actresses, automobiles, consumer products, media outlets or products, entertainment media or personal, any sports team or personnel, any individual, political figures or groups, religious symbols or groups, or anything or person the can be electronically depicted. In some instances, a user may be permitted to upload their own image to the voting kiosk 110 via USB, Bluetooth, Cloud or other near field communication means to upload the image for voting and to the server for other users to join in the voting. In the alternative, the personal image may be uploaded merely to permit the user to vent their frustration or relieve stress. In addition, the voting kiosk 110, when not used for voting and user registration, can be used to display advertisements and provide additional revenue and marketing avenues to the business. The voting kiosk 110 may be hard wired, have Bluetooth, wi-fi, cellular, or other methods for communication to the voting device 120 and the network to ensure connectivity and accuracy of voting.

The electronic voting system 100, as shown in FIG. 1, further comprises electronic voting devices 120. The electronic voting devices 120 are substantially water resistant and are configured to communicate with the voting kiosk 110 to display the desired image to be voted on, or disparaged. The electronic voting devices 120 may comprise an outer layer, shell, or case comprising plastic, ceramic, stainless steel or other water resistant material. The electronic voting devices 120 are configured to be fixably attached to urinals, toilets, sinks, bidets, and other fluid containing basins. Once the user activates the voting kiosk 110, the desired image is transmitted to the voting device 120. The image can be transferred through Bluetooth, wireless communication, hardwired communication, or other communication techniques. Once the user is in front of the particular restroom apparatus, for example a urinal, the user may then urinate on the voting device 120. The voting devices 120 may be configured to be activated through fluid contact or impingement. When a fluid stream contacts the display screen of the voting device 120, the fluid sensitive screen displays the fluid as it covers the image displayed on the voting device 120.

The electronic voting system 100 may be connected to the network and a website designed to record and display the results of the voting. The website may be free or alternatively pay for viewing. The votes may be geographically represented by specific categories on the website. The votes may also be presented with statistical analysis of the voting results. The representation on the web site records the total votes cast for particular categories and there is no limit to the number of votes cast. The voting system 100 may display the results from the website through the network on the voting kiosk 110 and the voting device 120. In additional, users may download a mobile application to their mobile devices to enable the mobile devices to receive the voting results. The voting results may be displayed in various graphical and analytical methods, such as bar graphs, pie graphs, tables, audible results, and other date presenting methods.

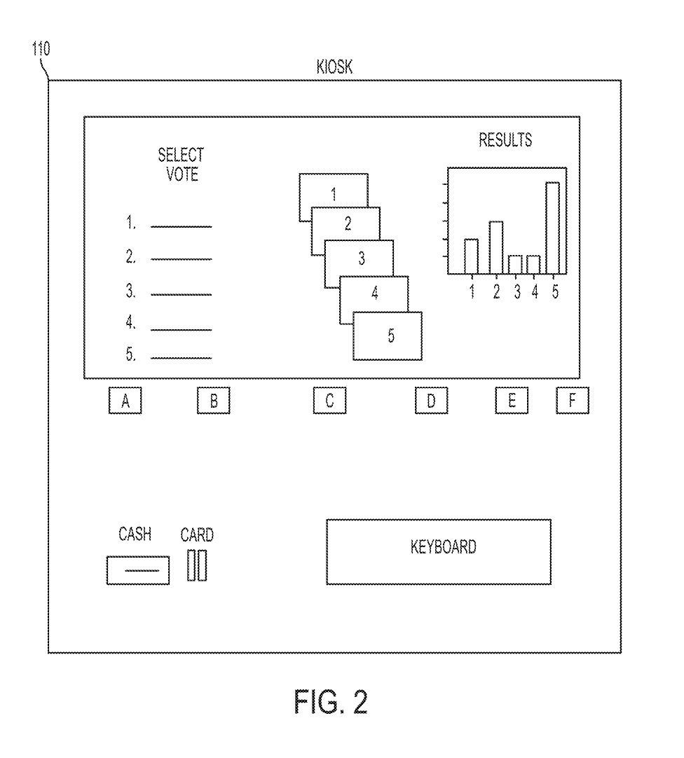

FIG. 2 depicts a voting kiosk 110, as seen in FIG. 1. The voting kiosk 110 may comprise a display screen/touch screen for user input, a keyboard for user input, selection buttons or switches, and a monetization module to accept cash, credit cards, debit cards, or coins. The monetization module may also comprise user inputted data, such as email address, phone numbers, and addresses may be collected for future monetization purposes, such as marketing and promotion communications. Other types of electronic currency may also be exchanged, for example using services such as PayPal, mobile device payment applications or Bitcoin. The voting system 100 may comprise display screen comprised of LED, plasma or similar technology and may be configured to be voice or touch activated. The voting kiosk 110 permits a user to search for voting categories, select a specific image to vote on, to register the vote and transmit the vote to an online server, where results from specific geographical locations and across the world can be tabulated and the results transmitted and displayed on the voting kiosk 110, websites, or module devices. The voting results may also be displayed locally where the voting devices 120 may communicate and display the results on a local voting kiosk 110.

Other voting and competitions are also contemplated through use of the electronic voting system 100. For example, a location, such as a bar may have competitions between beer manufactures in which the voting system 110 may be used to track votes and provide rewards to the winning side vote casters. In addition, the electronic voting system 100 could be used to track votes for a local event, such as a battle of the bands at a particular establishment that would allow the tabulation and display of the winning and losing bands based off of votes register through the voting system 100. Furthermore, the voting system 100 could incorporate a loyalty rewards program for frequent voters/users and certain thresholds may be established to permit the voter/user to unlock free votes or special or hidden voting categories.

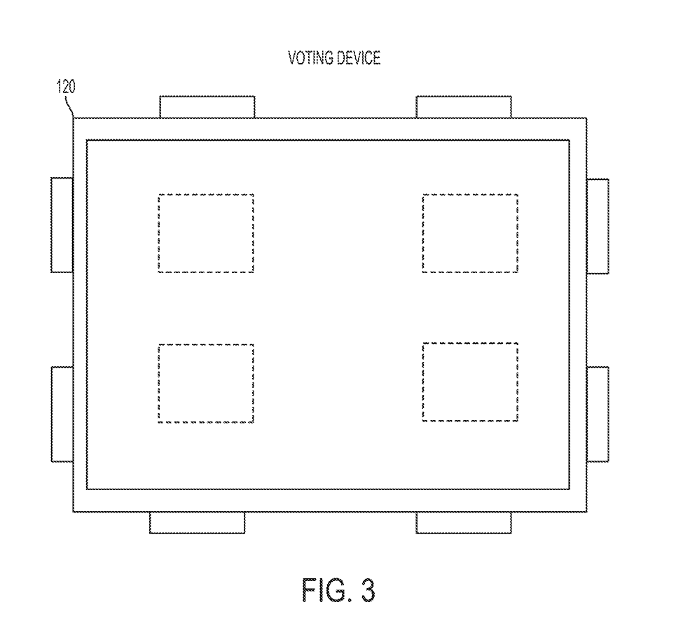

FIG. 3 illustrates an example of a voting device 120, as shown in FIG. 1. The voting device 120 comprises a substantially fluid resistant outer housing. The fluid resistant outer housing of the electronic voting devices 120 may comprise an outer layer, shell, or case comprising plastic, ceramic, stainless steel or other water resistant material. The display screen of the voting device 120 may comprise a hydro sensitive layer which is configured to detect interaction of fluid and may be integral with the housing to maintain the hydro sensitive characteristics and substantially fluid resistant outer housing. The display screen may also be LED, plasma or similar technology and may be configured to be voice or touch activated. The hydro sensitive layer is configured to detect the presence of a liquid stream contacting or impinging the display screen. The hydro sensitive layer is configured to depict the fluid stream on the display screen in a similar manner as a touch screen can register a signature through the use of a stylus or finger. This feature permits the fluid stream to depict a desired pattern, such as a shape, symbol, or signature. In addition to detecting and depicting a particular fluid pattern, the hydro sensitive layer is configured to sense and measure the amount of liquid dispensed across the display screen and can communicate the information to voting kiosk 110. Alternatively, as the voting device 120 is activated, a yellow depiction of graphic urine obscuring or covering the object or picture may be displayed as the vote is cast.

In addition to the hydro sensitive layer of the display screen, the display device may also comprise or in the alternative comprise various sensors and tracking mechanisms. For example, the sensors may comprise, but are not limited to pressure sensors, conductive sensors, inductance sensors, light sensors, laser and motion sensors, temperature sensors, pH sensors, vibration sensors, and physiological sensors. For example, the physiological sensors may comprise a blood alcohol level detection sensor that can provide the blood alcohol level of a voter through analysis of the voter's urine stream. In addition, the voting device 120 may detect the act of flushing through various sensors and may depict graphically the image being flushed on the display screen of the voting device 120 or other remote display screens. For example, the real-time voting may be displayed on the voting kiosk 110. Specific display screen sections may correspond to different votes, point levels, or different features that can be interacted with by the user. However, in the alternative, accuracy of the voting means, such as urination on a specific location of the voting device 120, may not be a desired attribute, and the voting device 120 may accept and register a vote through the happening of an action, rather than requiring a particular location specific interaction with the voting device 120.

The voting device 120 may be powered by an internal battery. The device may regenerate and recharge through hydroelectric generation through the voting and flushing process. In addition, the voting device 120 may be hard wired powered or may comprise an inductance wireless charging system that permits the voting device 120 to charge wirelessly. In addition, the voting device 120 may be fixable attached to the fluid basin through magnets, suction, hook and loop fasteners, clamps, levers, and other fastening devices. In addition, the voting device may comprise locking features to prevent the voting device from being stolen or removed from the restroom facility.

Alternative embodiments are within the scope of this disclosure. For example, the voting device 120 may be insertable in a urinal, toilet, sink, bidet, or other fluid containing basin and votes may be activated by water flushing, washing, rinsing, or urine contacting the hydro sensitive screen to cast the vote. Alternatively, the voting device 120 may be pre-fabricated into the body of a urinal, toilet, sink bidet, or other fluid containing basin and may be activated by similar means as discussed above. In either alternative, the votes may be activated by various sensors such as, for example, sensors comprising, but not limited to, pressure sensors, conductive sensors, inductance sensors, light sensors, laser and motion sensors, temperature sensors, pH sensors, vibration sensors, and physiological sensors.

In another exemplary embodiment, the image to be voted on may be projected onto the urinal, toilet, sink, bidet, or other fluid containing basins. The ballot and vote may then be recorded and cast through electrostatic properties of the liquid as discussed above. In addition, the votes may be recorded through sensors or detectors in a drain or through the disruption of the projected image. In another embodiment, votes may be cast by disrupting a laser or light beam within or adjacent the urinal, toilet, sink or bidet. Alternatively, the votes may be activated by various sensors such as, for example, sensors comprising, but not limited to, pressure sensors, conductive sensors, inductance sensors, light sensors, laser and motion sensors, temperature sensors, pH sensors, vibration sensors, and physiological sensors.

In addition to the voting means discussed above, the votes may also be recorded and cast through voice activation of the voting device. Votes may also be cast by user touch or manual disruption of a light or laser beam. Similar apparatus and screens to the voting device 120 discussed above can be placed adjacent to standard toilets, sinks, bidets, or other bathroom appliances with aforementioned vote registration means. In addition, for example, the act of defecation may also be registered by the user to cast a vote. Furthermore, other bodily fluid excretions may be used to vote, such as vomiting or spitting.

Similar apparatuses to the voting device 120 may be deployed around hand washing basins and sinks with similar vote registration methods as discussed above. In addition, the voting device 120 may include additional graphics, such as “I wash my hands of” a particular image as the vote is cast. Similarly, drains of the bathroom appliances may contain similar apparatuses on top or inside the drain to record votes as fluid passes over the sensors or disrupts the laser or light beams. The votes also may be activated by various sensors such as, for example, sensors comprising, but not limited to, pressure sensors, conductive sensors, inductance sensors, light sensors, laser and motion sensors, temperature sensors, pH sensors, vibration sensors, and physiological sensors.

In addition, the recording apparatus within the drains of the bathroom appliances may be invisible to the user and may be used to record restroom metrics, such as number of flushes, number of times sinks are used and number of people that wash their hands. Other recording metrics available may be to track the amount of liquid used in particular drains to assist in utility conservation and analysis, as well as determining when specific bathroom appliances may require routine or preventative maintenance.

Further to the above, the images and display screens may depict realistic images, such as actual video micturition on an object, or graphics that are artificial or artistic in nature. In addition, the objects and images may be actual photographs, videos, art renderings, drawings, caricatures, cartoons, or other visual displays. Furthermore, audio votes may be incorporated into the voting device. For example, votes can be cast against a certain celebrity's voice or a particular song using the vote casting methods discussed above.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, those skilled in the art will appreciate that the fasteners described herein (e.g., screws) may be replaced or supplemented by other suitable fastening means including a variety of other types of mechanical fastening devices (e.g., nails, rivets, magnets, or others). In another example, a particular choice of construction material (e.g., aluminum, plastic, steel, etc.) may be replaced or supplemented by another type of material which is suitable for the same or similar structure or function.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

It will be appreciated that, for convenience and clarity of disclosure, terms describing relative orientation or spatial positioning such as “proximal,” “distal,” “vertical,” “horizontal,” “up,” “down,” “top,” “front,” “back,” “bottom,” “upward,” or “downward” may be used at times herein with respect to the drawings and text description in association with various embodiments of the invention. However, such terms are primarily used for illustrative purposes and are not necessarily intended to be limiting in nature.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art. For example, there may be variations to these diagrams or the operations described herein without departing from the spirit of the invention.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as claimed.

What is claimed is:

1. An electronic voting system, comprising:
a voting kiosk, comprising:
a monetization module;
an electronic user interface; and
a recording and transmitting module;
a voting device, comprising:
an electronic display screen, wherein the electronic display screen is substantially fluid resistant, wherein the electronic display screen is configured to receive inputs from the voting kiosk to display an image;
a voting registration means, wherein the voting registration means is an action selected from the group consisting of urination, defecation, hand washing, toilet flushing, and bidet activation to register a vote;
a communication unit, wherein the communication unit is configured to register the vote and communicate with the voting kiosk, wherein when the voting kiosk receives the vote from the voting device, the voting kiosk is configured to transmit the vote to a server, wherein the server is configured to record the results from multiple voting kiosks, and wherein the server is configured to communicate the results to the voting kiosk, and wherein the voting kiosk is configured to display the results.

2. The electronic voting system of claim 1, wherein the electronic display screen is configured to depict a graphic obscuring the image when a vote is registered.

3. The electronic voting system of claim 1, wherein the monetization module is selected from the group consisting of a credit card reader, debit card reader, a bill acceptor, and a personal data collector.

4. An electronic voting device, comprising:
a liquid resistant housing;
an electronic display screen, wherein the electronic voting device is configured to receive an input from a server, and wherein the input corresponds to an image to be displayed via the electronic display screen;
a sensor, wherein the sensor is configured to detect a fluid stream impinging upon the electronic display screen, and upon detecting the impinging fluid, the sensor is configured to register a vote, wherein the electronic voting device is configured to transmit an output to a server, and wherein the output corresponds to the vote to be registered on the server.

5. The electronic voting device of claim 4, wherein the image is selected from the group consisting of an actor, an actress, an automobile, a consumer product, a media outlet, and entertainment media, a sports team, an individual, a political figure, and a religious symbol.

6. The electronic voting device of claim 4, wherein the electronic voting device is fixable attached to an apparatus selected from the group consisting of a urinal, a sink, a toilet, and a bidet.

7. A voting system, comprising:
a network to communicate data;
a voting kiosk, comprising:
a monetization module;
an electronic user interface; and
a recording and transmitting module;
a voting device, comprising:
an electronic display screen, wherein the electronic display screen is substantially fluid resistant, wherein the electronic display screen is configured to receive inputs from the voting kiosk to display an image;
a voting registration means, wherein the voting registration means is an action selected from the group consisting of urination, defecation, hand washing, toilet flushing, and bidet activation to register a vote;
a communication unit, wherein the communication unit is configured to register the vote and communicate with the voting kiosk, wherein when the voting kiosk receives the vote from the voting device, the voting kiosk is configured to transmit the vote to the network, wherein the network is configured to record the results from multiple voting kiosks, and wherein the network is configured to communicate the results to the voting kiosk, and wherein the voting kiosk is configured to display the results.

8. The voting system of claim 7, wherein the electronic display screen is configured to depict a graphic obscuring the image when a vote is registered.

9. The voting system of claim 7, wherein the monetization module is selected from the group consisting of a credit card reader, debit card reader, a bill acceptor, and a personal data collector.
